(19) United States
(12) Patent Application Publication
(10) Pub. No.: US 2025/0175003 A1
(43) Pub. Date: May 29, 2025

(54) SITE MANAGEMENT APPARATUS AND SITE MANAGEMENT METHOD

(71) Applicant: Hitachi Vantara, Ltd., Yokohama (JP)

(72) Inventor: Satoshi KANEKO, Tokyo (JP)

(73) Assignee: Hitachi Vantara, Ltd., Yokohama (JP)

(21) Appl. No.: 18/817,970

(22) Filed: Aug. 28, 2024

(30) Foreign Application Priority Data
Nov. 27, 2023 (JP) 2023-200112

(51) Int. Cl. H02J 3/38; H02J 3/00; H02J 13/00

(52) U.S. Cl. CPC H02J 3/38; H02J 3/003; H02J 3/004; H02J 13/00002; H02J 13/00006; H02J 2203/20

(57) ABSTRACT

A workload replacement planning program migrates an execution site that executes a workload by a migration plan created using a site energy management table. Also, the workload replacement planning program acquires error information indicating a deviation amount, which is the magnitude of a deviation between a first forecast value, which is a value shown in the site energy management table used to create a migration plan for a target amount, which is at least one of a renewable energy supply amount or an electric power demand amount, and a second forecast value of the target amount predicted after the first forecast value, and the deviation occurrence time point, which is the time point at which the deviation occurs. Then, the workload replacement planning program creates a corrected migration plan, in which the migration plan is corrected, based on the error information and the load-related information.

### CROSS-REFERENCE TO PRIOR APPLICATION

This application relates to and claims the benefit of priority from Japanese Patent Application No. 2023-200112 filed on Nov. 27, 2023 the entire disclosure of which is incorporated herein by reference.

### BACKGROUND

The present disclosure relates to a site management apparatus and a site management method.

The use of renewable energy is increasing as a measure against climate change. Conventionally, common methods to procure renewable energy have been through the purchase of certificates such as non-fossil certificates. However, in recent years, with the increase in the amount of available renewable energy, an increasing number of electric power companies are purchasing renewable energy directly from electric power generation companies through PPA (Power Purchase Agreement), for example, and acquiring environmental value through the transfer of certificates associated with the purchase. This trend is also seen in consumers who consume large amounts of electric power. With Data Centers (DC), which are bulk electric power consumers, electric power procurement through PPA is becoming popular, especially in Europe and the United States. Furthermore, with a view to increasing an utilization rate of renewable energy throughout society in the future, advanced electric power companies in Europe and the United States are working to increase the utilization rate of renewable energy on an hourly basis, instead of the current mainstream approach of increasing the utilization rate of renewable energy on an annual basis.

On the other hand, DCs, which are bulk electric power consumers, require large amounts of electric power throughout the day, hence the efficient use of renewable energy, which is unstable and has geographical constraints, is a challenge. In this respect, a technology is attracting attention that selects, among multiple DCs installed in different locations, DCs that execute Workloads (WL), according to the region and time of day in which renewable energy is abundant. With this technology, the reallocation of a workload is performed according to a reallocation plan that is formulated based on the forecast values of the amount of supply and the amount of demand for electric power from renewable energy.

For example, U.S. Patent Application Publication No. 2011/0282982 discloses a technology for automatically relocating application instances based on forecast values of the supply amount of electric power (including electric power from renewable energy) supplied to each of multiple hosting sites that execute application instances, the cost for the supply amount, and the availability of the computing resources at each hosting site.

In the technology described in U.S. Patent Application Publication No. 2011/0282982, the reallocation of application instances is performed at specified intervals. However, since predicted results such as the electric power supply amount can change over time, forecast values such as the electric power supply amount can also change during that interval. In this case, the reallocation plan may deviate from appropriate values. As a result, the use of electric power from renewable energy may decrease, increasing CO₂ emissions, or increasing costs.

### SUMMARY

It is an object of the present invention to provide a site management apparatus and a site management method that are capable of using electric power from renewable energy more efficiently.

A site management apparatus according to one aspect of the present disclosure is a site management apparatus for managing a plurality of sites capable of executing a workload for performing calculation processing, the site management apparatus including a processor and a memory, wherein the memory is configured to store: electric power management information indicating, for each of the sites, a forecast value of a target amount that is at least one of a supply amount, which is an amount of electric power from renewable energy to be supplied to the site, or a demand amount, which is an amount of electric power to be consumed at the site; and load-related information indicating, for each of the workloads, an electric power consumption amount that is an amount of electric power to be consumed by the workload, an execution site that is the site executing the workload, and an estimated migration time that is an estimate of a migration time required to migrate the execution site to another site, and the processor is configured to: migrate the execution site of each workload in accordance with a migration plan for migrating the execution site of each workload created using the electric power management information; acquire error information indicating a deviation amount that is a magnitude of deviation between a first forecast value that is the forecast value indicated by electric power management information used to create the migration plan and a second forecast value of the target amount that is predicted after the first forecast value, and a deviation occurrence time point at which the deviation occurs; and create a corrected migration plan in which the migration plan is corrected based on error information and the load-related information.

According to the present invention, it is possible to use electric power from renewable energy more efficiently.

### BRIEF DESCRIPTION OF THE DRAWINGS

FIG. 1 is a diagram illustrating the overall configuration of a multi-site data center management system according to an embodiment of the present disclosure;

FIG. 2 is a diagram illustrating the configuration of a multi-site management server;

FIG. 3 is a diagram illustrating an example of a site energy management table;

FIG. 4 is a diagram illustrating an example of a placement policy table;

FIG. 5 is a diagram illustrating an example of a workload management table;

FIG. 6 is a diagram illustrating an example of a storage management table;

FIG. 7 is a diagram illustrating an example of an application management table;

FIG. 8 is a diagram illustrating an example of a migration time table;

FIG. 9 is a flowchart illustrating an example of a migration plan correction process; and

FIG. 10 is a diagram showing an example of an operation result screen.

### DETAILED DESCRIPTION OF THE EMBODIMENT

Referring to the drawings, embodiments of the present disclosure are described below. Note that the embodiments described below do not limit the invention according to the claims, and not all of the elements and combinations thereof described in the embodiments are necessarily essential to the solution of the invention.

Also, in the following description, various types of information may be described using the expression “aaa table”, but various types of information may be expressed in a data structure other than a table. To indicate the independence from a data structure, “aaa table” may be referred to as “aaa information”. Additionally, in the following description, a “program” may be used as the subject, but since a program is executed by a processor (e.g., a CPU (Central Processing Unit) or a GPU (Graphics Processing Unit)) to perform the specified processing by appropriately using storage resources (e.g., memory) and interface devices (e.g., communication apparatuses), the explanation may also be based on the processor as the subject. Similarly, the subject that executes a program and performs processing may be a controller, an apparatus, a system, a computer, a node, a storage apparatus, a server, a client, or a host that includes a processor. Also, a part or all of the program may be processed using a specific hardware circuit. Furthermore, various programs may be installed in each computer via a program distribution server or storage media. In the following description, two or more programs may be implemented as one program, and conversely, one program may be implemented as two or more programs.

In the following description, an ID is used as identification information for an element, but other types of identification information may be used instead of or in addition to the ID.

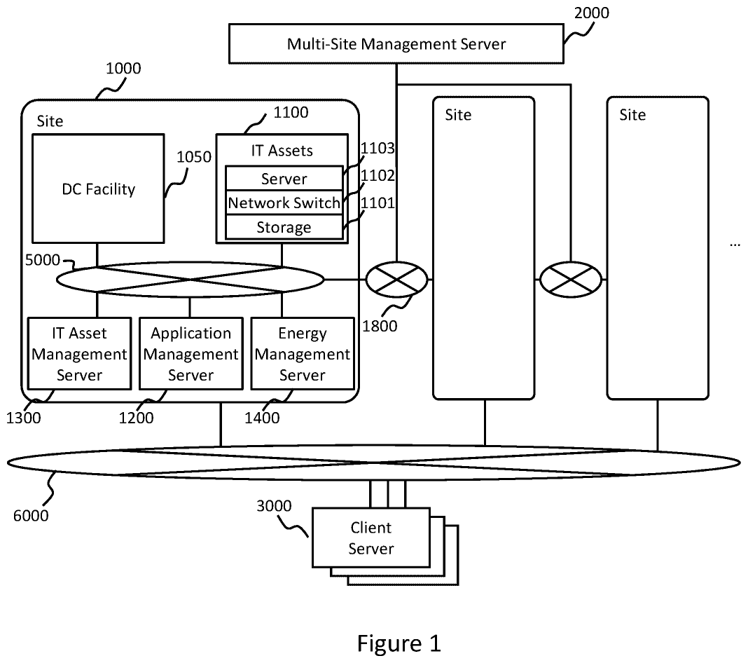

FIG. 1 is a diagram illustrating the overall configuration of a multi-site data center management system, which is a computer system according to an embodiment of the present disclosure. The multi-site data center management system shown in FIG. 1 includes a plurality of site systems 1000, a multi-site management server 2000, and a client server 3000.

Each site system 1000 is a location where a data center (DC) is located. The DC is a group of apparatuses that stores data and executes applications for performing workloads (calculation processing) using the data. For example, the site systems 1000 are installed in geographically separated locations. Furthermore, one site system 1000 may have multiple DCs. Each site system 1000 or each DC may build a different cloud environment, such as on-premise, public cloud, or private cloud. In other words, the present disclosure is applicable to what is known as a hybrid cloud that has multiple different cloud environments.

The multi-site management server 2000 is a site management apparatus (management computer) that manages the execution of applications by each DC and the configuration of each apparatus based on information about the DCs located at the site systems 1000. The multi-site management server 2000 is communicably coupled to the DCs present at the site systems 1000 via a wide area network 1800.

The client server 3000 is a client computer used by a user of the DC and is communicably coupled to the DCs located at the site systems 1000 via a client network 6000. The client server 3000 transmits various instructions, such as an instruction to execute an application, to the DCs, and receives a response from the DCs in response to the instructions.

Each site system 1000 includes, as components forming a DC, a DC facility 1050, an IT asset 1100, an application management server 1200, an IT asset management server 1300, and an energy management server 1400, which are coupled so that they can communicate with each other via a management network 5000.

The DC facility 1050 is a facility used to operate the DC and may be an air conditioning facility and a backup electric power facility, such as a UPS (Uninterruptible Power Supply), for example.

The IT asset 1100 is a device forming the DC main body and is a processing computer for storing data and executing a workload using that data. In the example of FIG. 1, the IT asset 1100 includes a storage 1101 for storing data, a network switch 1102 for managing communication of data and the like, and a server 1103 for executing an application that performs workload using data.

The application management server 1200 is a management computer that manages applications executed by the server 1103 of the IT asset 1100, and acquires and stores application management information regarding the applications.

The IT asset management server 1300 is a management computer that manages the IT asset 1100, and acquires and stores IT asset information regarding the IT asset 1100. The IT asset information includes, for example, configuration information indicating the coupling relationships of the IT asset 1100, and performance information indicating the usage status of the resources (such as CPU, network card, and disk) that constitute the IT asset 1100.

The energy management server 1400 is a management computer that manages the electric power consumption consumed by the DC, and acquires and stores electric power information regarding the electric power consumption. The electric power consumption of the DC includes not only the electric power consumed by the IT asset 1100 but also the electric power consumed by the DC facility 1050 and the like.

In this embodiment, the management computers (application management server 1200, IT asset management server 1300, and energy management server 1400) are distributed, but any one of the management computers may be consolidated with another management computer. Also, in this embodiment, the multi-site management server 2000 is independent of the site systems 1000, but may be provided at any one of the site systems 1000.

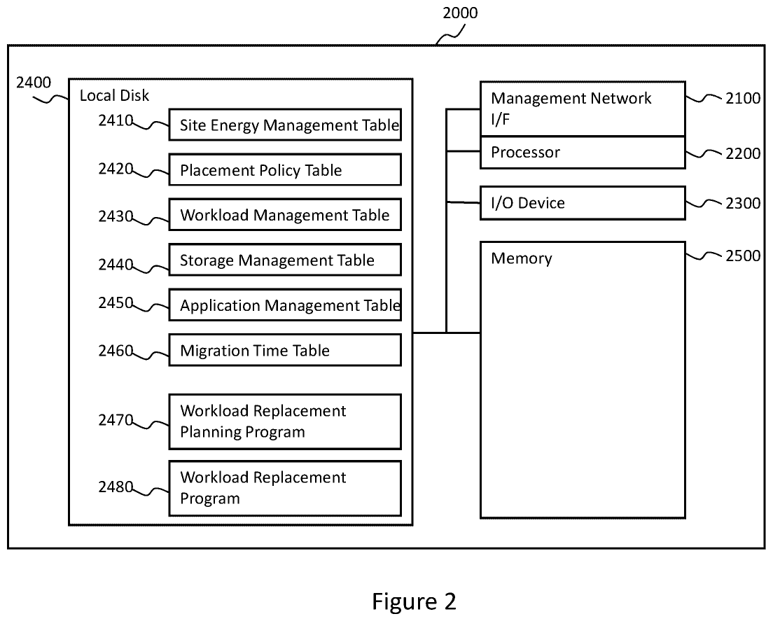

FIG. 2 is a diagram showing the configuration of the multi-site management server 2000. As shown in FIG. 2, the multi-site management server 2000 includes a management network interface (I/F) 2100, a processor 2200, an Input and output (IO) device 2300, a local disk 2400, and a memory 2500.

The management network I/F 2100 is communicably coupled to the devices in the site systems 1000 shown in FIG. 1. The IO device 2300 is a user interface, such as a monitor, keyboard, and mouse, for inputting and outputting information to and from the user.

The processor 2200 is a processing portion that performs various processes by loading programs into the memory 2500 and executing them. The local disk 2400 is a storage apparatus that stores programs that define the operations of the processor 2200 and various types of information used or generated in the processes of these programs. The memory 2500 is a main storage apparatus that temporarily stores various types of information and is used as a work area for programs.

In this embodiment, the local disk 2400 stores, as information, a site energy management table 2410, a placement policy table 2420, a workload management table 2430, a storage management table 2440, an application management table 2450, and a migration time table 2460. The local disk 2400 also stores, as programs, a workload replacement planning program 2470 and a workload replacement program 2480.

The site energy management table 2410 is electric power management information, which includes electric power status information regarding the electric power status at each time point in each site system 1000. The multi-site management server 2000 acquires at least part of the electric power information stored in the energy management server 1400 and manages it as a site energy management table 2410. The electric power status indicates, for example, at least one of the renewable energy supply amounts, which is the amount of electric power from renewable energy supplied to the site system 1000, and the electric power demand amount, which is the amount of electric power consumed at the site. The electric power status information includes a forecast value regarding the electric power status, and may also include an actual measured value regarding the electric power status, electric power price information, and the like. There are no particular limitations on the method for creating the site energy management table 2410. For example, the forecast value regarding the electric power status may be acquired from the energy management server 1400, or may be calculated by the multi-site management server 2000 from actual values or the like.

The placement policy table 2420, the workload management table 2430, the storage management table 2440, the application management table 2450, and the migration time table 2460 constitute load-related information regarding the workload executed in each site system 1000 (each DC).

The placement policy table 2420 includes placement policy information indicating placement policies, which are policies regarding the migration (relocation) of workload. The migration of workload is performed by migrating (changing) the execution site, which is the site system 1000 (DC) that executes the workload, to another site. There are no particular limitations on the method for creating the placement policy table 2420. For example, the placement policy table 2420 may be created by the multi-site management server 2000 or by another computer such as the IT asset management server 1300.

The workload management table 2430 includes workload information, which is information regarding the workload that constitutes the application to be executed by the server 1103 of the IT asset 1100. The multi-site management server 2000 acquires at least part of the application management information stored in the application management server 1200 and manages it as the workload management table 2430.

The storage management table 2440 includes storage information regarding the storage 1101 which stores data used by the workload that constitutes the application. The storage information includes information acquired by the multi-site management server 2000 from the IT asset management server 1300, but may also be created from data acquired from other management computers.

The application management table 2450 includes application information, which is information regarding applications to be executed by the server 1103 of the IT asset 1100. The application information is acquired by the multi-site management server 2000 from the application management server 1200, but may also be created from data acquired from other management computers.

The migration time table 2460 includes migration-related information regarding the migration of workload to be executed by the server 1103 of the IT asset 1100. The migration-related information is acquired by the multi-site management server 2000 from the application management information stored in the application management server 1200, but may also be created from data acquired from other management computers.

The workload replacement planning program 2470 is a program for creating a migration plan for migrating the execution site of workload to another site. The migration plan indicates, for example, a migration target load, which is a target workload of migration, a migration source and a migration target of the execution site that executes the migration target load.

The workload replacement planning program 2470 creates a migration plan based on the information stored in the local disk 2400. For example, the workload replacement planning program 2470 creates a migration plan so that the renewable energy supply amount, which is the amount of electric power from renewable energy supplied to the site system 1000, is used to the maximum extent possible. The migration plan indicates, for example, the workload to be migrated, the migration target site, the migration type, and the like, at predetermined intervals (for example, 30 minutes).

Also, the workload replacement planning program 2470 creates a corrected migration plan in which the migration plan is corrected based on error information indicating the error between a first forecast value, which is a value shown in the site energy management table 2410 used to create a migration plan for a target amount, which is at least one of a renewable energy supply amount or an electric power demand amount, and a second forecast value, which is a value predicted after the first forecast value of the target amount. For example, the error information indicates the amount of deviation, which is the magnitude of the deviation between the first forecast value and the second forecast value, and the deviation occurrence time point at which the deviation occurs. When the target amount is both the renewable energy supply amount and the electric power demand amount, the deviation amount indicated by the error information may be the sum of the deviation amounts of the renewable energy supply amount and the electric power demand amount, for example.

The workload replacement program 2480 migrates the execution site of the workload by the migration plan and the corrected migration plan created by the workload replacement planning program 2470.

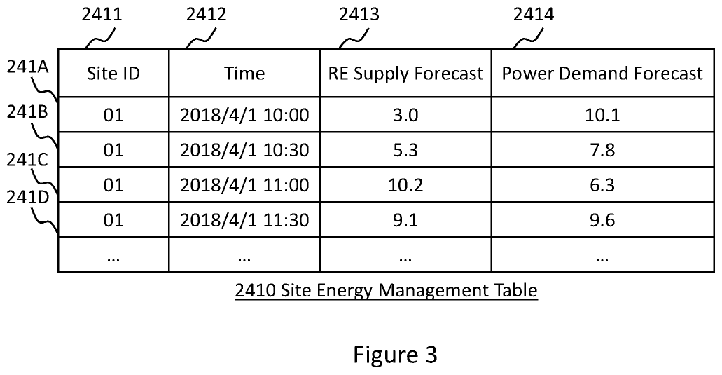

FIG. 3 is a diagram showing an example of the site energy management table 2410. The site energy management table 2410 shown in FIG. 3 includes columns 2411 to 2414.

Column 2411 stores a site ID, which is identification information for identifying a site system 1000. Column 2412 stores a time stamp (time) indicating a time point. Column 2413 stores RE supply forecast, which is a forecast value of the supply amount of electric power from renewable energy at the relevant site (the site system 1000 of the site ID in the same record) at the relevant time point (the time point indicated by the time stamp in the same record). Column 2414 stores a power demand forecast, which is a forecast value of the amount of electric power demand at the relevant site at the relevant time point.

Each of records 241A to 241D in the site energy management table 2410 indicates the electric power status information of the site system 1000 in chronological order. For example, record 241A indicates that the RE supply forecast is 3.0 MW and the power demand forecast is 10.1 MW as of “2018/4/1/10:00” at the site with site ID “01.”

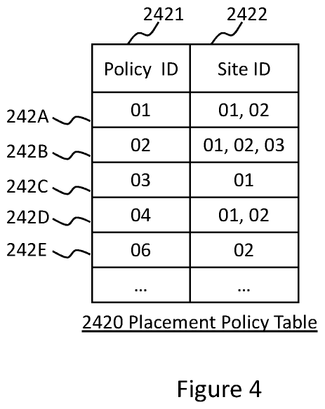

FIG. 4 is a diagram showing an example of the placement policy table 2420. The placement policy table 2420 shown in FIG. 4 includes columns 2421 to 2422.

Column 2421 stores a policy ID for identifying a placement policy. Column 2422 stores the site IDs of the site systems 1000 in which an application can be placed, as the content of the relevant placement policy (the placement policy of the policy ID in the same record).

Each of records 242A to 242E in the placement policy table 2420 indicates application placement policy information. For example, in record 242A, the placement policy of policy ID “01” indicates that the application can be placed in the site systems 1000 with site IDs “01” and “02”. Also, when there is only one site ID, as in records 242C and 242E, the placement policy of that record indicates that the application cannot be relocated.

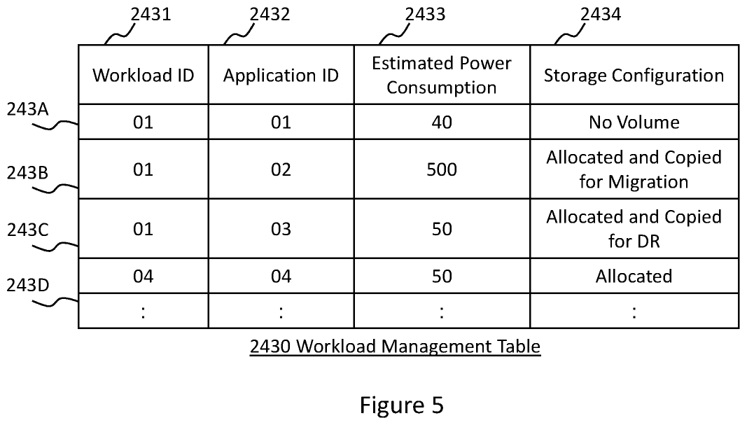

FIG. 5 is a diagram showing an example of the workload management table 2430. The workload management table 2430 shown in FIG. 5 includes columns 2431 to 2434.

Column 2431 stores a workload ID, which is identification information for identifying a workload. Column 2432 stores an application ID for identifying an application including the relevant workload (the workload of the workload ID in the same record). Column 2433 stores estimated power consumption, which is an estimate of the amount of electric power consumed by the relevant workload. Column 2434 stores storage configuration indicating the configuration of the storage 1101 used for the relevant workload.

The storage configuration indicates whether a volume is allocated to the application including the workload (that is, whether there is data used by the application) and whether the data has been copied. Specifically, the storage configuration indicates “No Volume” when no volume is allocated to the application, and indicates “Allocated” when a volume is allocated to the application. Also, the storage configuration indicates “Allocated and Copied for Migration” when a volume is allocated to the application and the data is copied for application migration, and indicates “Allocated and Copied for DR” when a volume is allocated to the application and the data is copied for application disaster recovery. Note that copying of data may also be performed for other purposes such as backup. Furthermore, the purpose of copying (application migration and disaster recovery) does not need to be indicated.

Each of records 243A to 243D in the workload management table 2430 indicates workload information of each workload. For example, record 243A indicates that the workload with workload ID “01” constitutes the application with application ID “01”, its power consumption is 40 w, and no volume, which is a storage area, is allocated.

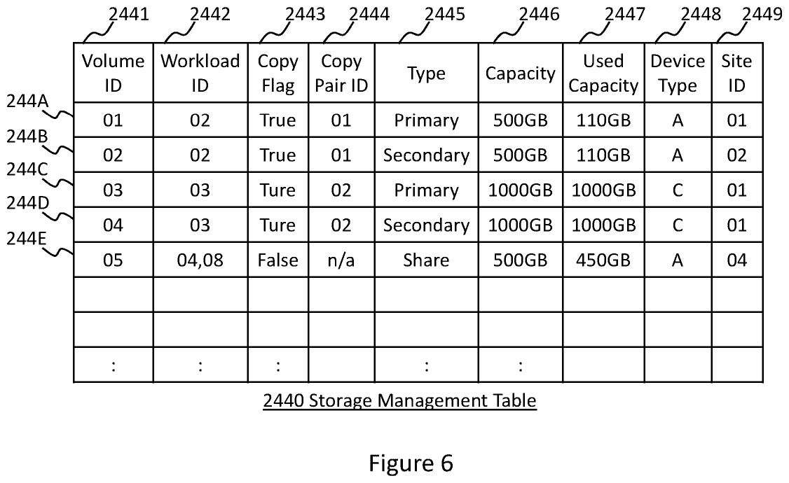

FIG. 6 is a diagram showing an example of the storage management table 2440. The storage management table 2440 shown in FIG. 6 includes columns 2441 to 2449.

Column 2441 stores a volume ID, which is identification information for identifying a volume. Column 2442 stores the workload ID of the workload that constitutes the application to which the relevant volume (the volume with the volume ID in the same record) is allocated. Column 2443 stores a copy flag indicating whether the data of the relevant volume is in a copy state in which the data of the volume is copied to another volume. In this embodiment, the copy flag indicates “True” when the state is the copy state, and indicates “False” when the state is not the copy state. Column 2444 stores a copy pair ID, which is identification information for identifying the copy pair of the volume. The copy pair is a combination of the copy source and the copy target of the volume in the copy state, and the copy pair ID indicates “n/a” when the volume is not in the copy state. Column 2445 stores the type of volume in the copy pair. The type indicates “Primary” when the volume is a primary volume, which is the copy source, and indicates “Secondary” when the volume is a secondary volume, which is the copy target. Column 2446 stores the capacity of the relevant volume. Column 2447 stores the used capacity of the relevant volume. The sum of the used capacities of the volume allocated to the application is the amount of data used by the application. Column 2448 stores the device type, which is the type of device (storage 1101) to which the volume is allocated. Column 2449 stores the site ID of the site system 1000 that has the relevant volume.

Each of records 244A to 244E of the storage management table 2440 indicates storage information. For example, record 244A indicates that the volume with volume ID “01” is allocated to the workload with workload ID “02”, the relevant volume is in the copy state, has copy pair ID “01”, is a primary volume, has a capacity of “500 GB” of which “110 GB” has been used, has a device type of “A”, and is located at the site system 1000 with site ID “01”. The volumes corresponding to the records 244A and 244B constitute a copy pair. Record 244E indicates a state in which no copy pair is configured, and the data is shared between the sites by the workload with workload ID “04” and the workload with workload ID “08”. This configuration enables a switch access path, which is one of the migration types described below.

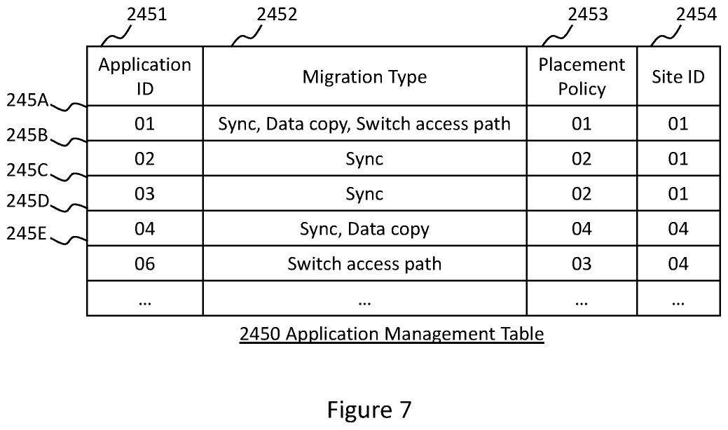

FIG. 7 is a diagram showing an example of the application management table 2450. The application management table 2450 shown in FIG. 7 includes columns 2451 to 2454.

Column 2451 stores an application ID. Column 2452 stores a migration type, which is a migration method permitted for the relevant application (the application with the application ID in the same record). Column 2453 stores the policy ID of the placement policy configured for the relevant application. Column 2454 stores the site ID of the site where the relevant application is executed.

In this embodiment, the types of migration include data copy, switch access path, and Sync (Synchronization): synchronization target migration). Data copy is a migration method that, when migrating a workload, copies the data to be used in the workload from the migration source site system 1000 to the migration target site system 1000, and uses the copied data after migration. Switch access path is a migration method that does not migrate the data to be used in the workload to the migration target site system 1000 and uses the data of the migration source even after migration. Sync is a migration method that migrates the execution site to the site system 1000 to which the data to be used in the workload is synchronously copied in advance, and uses the synchronously copied data after migration.

Each of records 245A to 245E of the application management table 2450 indicates application information. For example, record 245A indicates that the types of migration permitted for the application with application ID “01” are “Sync”, “data copy”, and “switch access path”, the placement policy with policy ID “01” is configured for the application, and the application is executed at the site with site ID “01”.

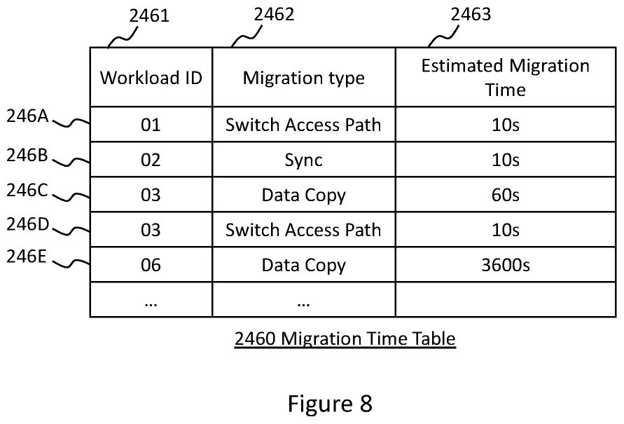

FIG. 8 is a diagram showing an example of the migration time table 2460. The migration time table 2460 shown in FIG. 8 includes columns 2461 to 2463.

Column 2461 stores a workload ID. Column 2462 stores one of the types of migration permitted for the relevant workload (the workload of the workload ID in the same record). Column 2463 stores an estimated migration time, which is an estimate of the migration time required when the relevant workload is migrated by the relevant migration type (the migration type in the same record).

Each of records 246A to 246E of the migration time table 2460 indicates migration-related information. For example, record 246A indicates that the estimated migration time by switch access path for the workload with workload ID “01” is “10 seconds”. Record 246C indicates that the estimated migration time by “data copy” of the workload with workload ID “03” is “60 seconds,” and record 246D indicates that the estimated migration time by “switch access path” of the workload with workload ID “03” is “10 seconds”.

The migration time of workload varies depending on factors including the time required to stop the workload being executed at the migration source site system 1000, the time required to start the workload to be executed at the migration target site system 1000, and the time required to copy the data to be used in the workload to the migration target site system 1000. As such, the estimated migration time is calculated based on the migration type of the workload, the type of storage that stores the data to be used in the workload at the site systems 1000 before and after the migration, and the amount of data, for example. For example, the multi-site management server 2000 may calculate an estimated migration time based on the workload management table 2430 and the storage management table 2440, for example, and add the calculated estimated migration time to the migration time table 2460.

For example, as indicated by record 244A of the storage management table 2440, the volume with volume ID “01” is a storage area allocated to the workload with workload ID “02”, and since the copy flag is “True”, 110 GB of used data has been copied to the volume with volume ID “02” at the site with site ID “02”, which has the same copy pair ID “01”. Thus, the multi-site management server 2000 estimates the time required for switching the workload to be the time required for the workload migration, calculates this time as an estimated migration time, and adds it to the migration time table 2460.

Also, as indicated by record 244E of storage management table 2440, the copy flag of the volume with volume ID “05” is “False”, and thus the data is not copied. As such, the multi-site management server 2000 determines that the time required to migrate the workload includes the time required to copy 450 GB of used data to the migration target, and further determines the throughput (MB/s) performance of the storage medium from the device type information in the storage management table 2440 and the network transfer performance (bps) between the source site and the target site from the site ID information. Based on this information pieces, the multi-site management server 2000 calculates the time required for migration as an estimated migration time and adds it to the migration time table 2460. The method of calculating the migration time is not limited to the method described above, and may be a method that uses a machine learning model created using data on past migration configurations and migration times. The advantageous effects of the present disclosure do not depend on the method of calculating the migration time.

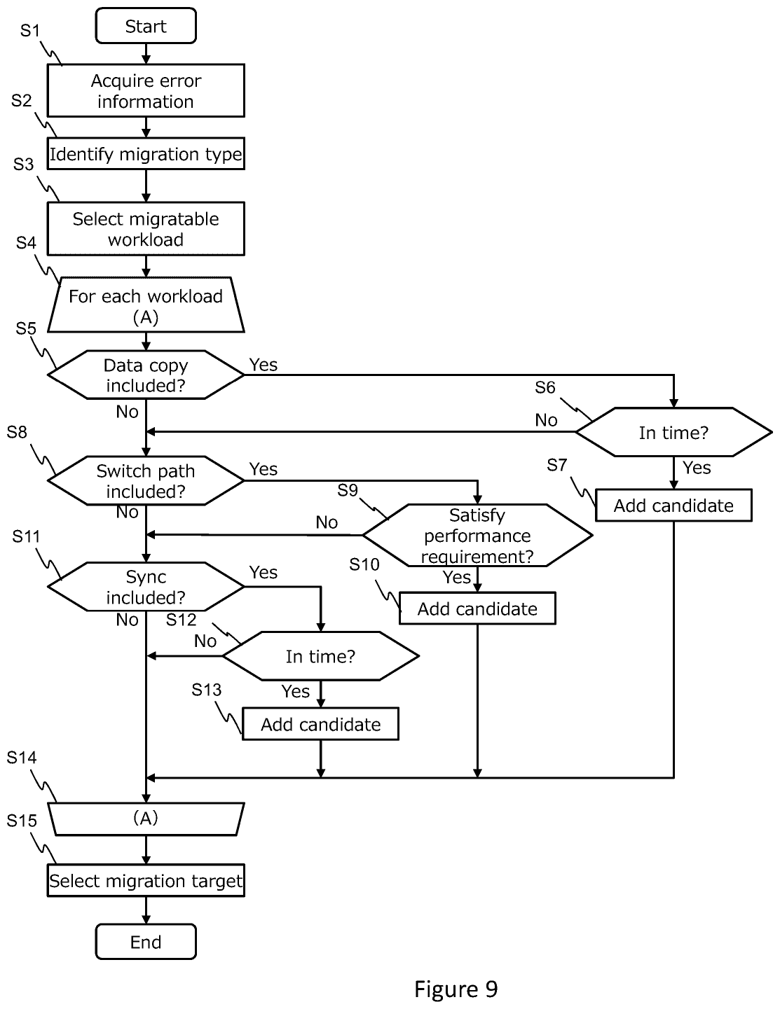

FIG. 9 is a flowchart illustrating an example of a migration plan correction process for creating a corrected migration plan using the workload replacement planning program 2470. Although a case is described below in which the workload of the target site, which is the site to which the workload is migrated, is reduced, the following description also applies to a case in which the workload of the target site is increased. For example, a case in which the workload of the target site is increased is equivalent to a case in which the workload of a different site is reduced, and the following description may be applied to this different site.

First, the workload replacement planning program 2470 acquires error information indicating an error between a first forecast value, which is at least one of the RE supply forecast or the power demand forecast of each site system 1000 used to create the migration plan, and a second forecast value predicted after the first forecast value (step S1).

There are no particular limitations on the method for acquiring the error information. For example, the workload replacement planning program 2470 may receive error information from the energy management server 1400 of each site system 1000, or may receive information indicating the second forecast value from the energy management server 1400 of each site system 1000 and calculate the error information based on the received information and the site energy management table 2410 stored in the local disk 2400.

Furthermore, the workload replacement planning program 2470 may acquire error information for all site systems 1000, or may acquire error information for a specific site system 1000. For example, the workload replacement planning program 2470 may receive error information about a target site, which is the site to which a workload is to be migrated, together with information indicating the target site, from the energy management server 1400 of the target site. The information indicating the target site may be the site ID of the target site, for example.

Upon acquiring the error information, the workload replacement planning program 2470 identifies, for each workload, the migration type permitted for the application being executed at the target site, based on the workload management table 2430 and the application management table 2450 (step S2). Specifically, the workload replacement planning program 2470 identifies the application being executed at the target site based on the site ID in column 2454 and the application ID in column 2451 of the application management table 2450. The workload replacement planning program 2470 identifies the migration type permitted for the identified application as the migration type of the workload, based on the workload ID in column 2431 of the workload management table 2430, the application ID in column 2432 of the workload management table 2430, and the migration type in column 2452 of the application management table 2450. The target site may be selected using the site ID received together with the error information, or a site that meets a specific condition, such as the site with the largest error among the error information of the sites, may be selected.

The workload replacement planning program 2470 also selects, from the workloads being executed at the target site, a target workload for which the execution site can be migrated, based on the placement policy table 2420, the workload management table 2430, the storage management table 2440, and the application management table 2450 (step S3). Specifically, the workload replacement planning program 2470 identifies the policy ID of the placement policy configured for the application from column 2453 of the application management table 2450. The workload replacement planning program 2470 identifies the site ID of the site system 1000 in which the application can be placed, based on the identified policy ID and the placement policy table 2420. When selecting migratable workloads, the workload replacement planning program 2470 selects only migratable workloads based on the information on the workload management table 2430 and the storage management table 2440 in addition to the information on the migration type permitted for the application identified at step S2. For example, record 244E of the storage management table 2440 shows an example of a configuration that enables the switch access path as described above. Even when the migration types of the application including the workload of a migration target include the switch access path, the workload cannot be migrated and is thus excluded from the migration targets unless the storage configuration is the configuration exemplified in record 244E of storage management table 2440. In this manner, the storage management table 2440 further indicates the execution sites at which a workload can be executed with consideration given to the migration type permitted for the workload and the storage configuration.

The workload replacement planning program 2470 starts a loop process A in which the candidate selection process from step S5 to step S13 is repeated for each of the selected workloads (step S4).

In the candidate selection process, the workload replacement planning program 2470 first determines whether data copy is included in the migration type permitted for the target workload (Step S5).

If the migration type includes data copy (step S5: Yes), the workload replacement planning program 2470 determines whether the migration time required to migrate the execution site by data copy of the target workload is shorter than the remaining time from the current time point to the specified time point (step S6). As the migration time, the estimated migration time in the migration time table 2460 may be used, or the migration time may be calculated by the workload replacement planning program 2470 in the same manner as the calculation method of the estimated migration time. For example, the specified time point may be the deviation occurrence time point, which is included in the error information.

If the migration time is shorter than the remaining time (Yes at step S6), the workload replacement planning program 2470 selects the target workload as a candidate for a migration target load, which is a workload for which the execution site is to be migrated, and adds the migration target load candidate to the migration candidate list in association with its migration type (data copy) (step S7).

If data copy is not in the migration type (No at step S5), or if the migration time is equal to or greater than the remaining time (No at step S6), the workload replacement planning program 2470 determines whether the migration type permitted for the target workload include switch access path (step S8).

If the migration type includes the switch access path (Yes at step S8), the workload replacement planning program 2470 determines whether the target workload after the migration of the execution site satisfies a predetermined performance requirement (step S9). Specifically, the workload replacement planning program 2470 calculates a performance estimate value by evaluating the performance of the target workload after migration based on the configurations of the migration target and the site system 1000 after migration, and determines whether the performance estimate value satisfies the predetermined performance requirement. For example, the predetermined performance requirement may be specified by a user who uses the application including the workload. Furthermore, the performance estimate value may be calculated from the actual measured value of the network performance between the site systems 1000, or may be calculated by other methods. Furthermore, the performance estimate value may be calculated in advance and stored in the local disk 2400 or the like.

If the target workload satisfies the performance requirement (YES at step S9), the workload replacement planning program 2470 selects the target workload as a candidate for migration target load, and adds the migration target load candidate to the migration candidate list in association with its migration type (switch access path) (step S10).

If the migration type does not include the switch access path (No at step S8), or if the target workload does not satisfy the performance requirement (No at step S9), the workload replacement planning program 2470 determines whether the migration type permitted for the target workload includes sync (step S11).

If the migration type includes sync (Yes at step S11), the workload replacement planning program 2470 determines whether the migration time required to migrate the execution site by sync of the target workload is shorter than the remaining time from the current time point to the specified time point (step S12). The specific determination method is the same as the processing at step S6.

If the migration time is shorter than the remaining time (Yes at step S12), the workload replacement planning program 2470 selects the target workload as a candidate for the migration target load and adds the migration target load candidate to the migration candidate list in association with its migration type (sync) (step S13).

If the migration type does not include sync (No at step S11), if the migration time is equal to or greater than the remaining time (No at step S12), or if the processing of step S13 is completed, the candidate selection process for the target workload is terminated. Then, when the candidate selection process of steps S5 to S13 is completed for all the target workloads, the workload replacement planning program 2470 ends the loop process A (step S14).

The workload replacement planning program 2470 then selects a migration target load, which is the workload for which the execution site is actually migrated, from the migration candidate list based on the error information and the workload management table 2430, creates a migration plan to migrate the migration target load as a corrected migration plan (step S15), and completes the process. When selecting the migration target load, based on the estimated power consumption of the workload in the workload management table 2430 and the deviation amount of error information, the workload replacement planning program 2470 selects the workload as the migration target load such that the sum of the estimated power consumptions corresponds to the deviation amount. Here, the sum of the estimated power consumptions corresponding to the deviation amount refers to the sum of the estimated power consumption equal to or substantially equal to the deviation amount.

The migration plan correction process described above is merely an example, and is not limited to this. For example, in the loop process, rather than repeating the candidate selection process for all target workloads, the workload replacement planning program 2470 may terminate the loop process when the sum of the estimated electric power consumptions corresponds to the deviation amount by selecting workloads, or may terminate the loop process when another termination condition is satisfied.

Also, even when the migration type includes the switch access path (Yes at step S8), the workload replacement planning program 2470 may perform processing of determining whether the migration time is shorter than the time before the specified time point, similar to steps S6 and S12.

When the error information acquired at step S1 includes multiple deviation occurrence time points, the workload replacement planning program 2470 may create multiple time slots based on the multiple deviation occurrence time points, and perform the processing of steps S2 to S15 for each time slot. For example, when the deviation occurrence time points are “2018/4/1 10:00” and “2018/4/1 10:30”, the workload replacement planning program 2470 creates a 30-minute time slot from “2018/4/1 10:00” to “2018/4/1 10:30” and a 30-minute time slot from “2018/4/1 10:30” to “2018/4/1 11:00”, and performs the processing of steps S2 to S15 for the two time slots.

When the workload replacement planning program 2470 creates a corrected migration plan, the workload replacement program 2480 migrates the execution site of the workload in accordance with the corrected migration plan. At this time, when the migration type of the workload is sync, the synchronization state of the data is maintained after migration. In this case, when the workload is migrated again to the source site system 1000, data copy is not needed, allowing for quick migration of the execution site.

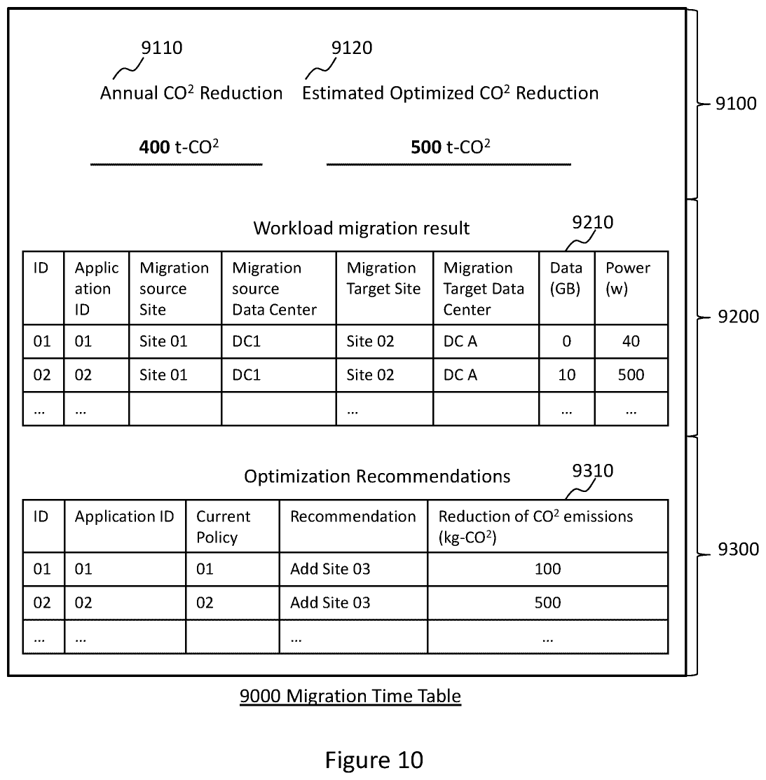

FIG. 10 is a diagram showing a GUI (Graphical User Interface) that is an example of a display screen presenting the result of DC operation using the migration plan created by the workload replacement planning program 2470 and operation improvements.

The GUI 9000 shown in FIG. 10 is an example of a screen presented by the workload replacement planning program 2470 to a user (such as a user of a data center), and is divided into an upper part 9100, a middle part 9200, and a lower part 9300.

The upper part 9100 includes an annual CO₂ reduction 9110 indicating the effect of the DC's CO₂ emission reduction resulting from the current placement policy, and an estimated optimized CO₂ reduction 9120 indicating the effect of the DC's CO₂ emission reduction resulting from a change in the placement policy. A detailed description of the change in the placement policy is omitted.

The middle part 9200 includes table 9210 showing the workload migration result. Table 9210 is information showing the contents of a corrected migration plan as a migration plan for resolving the shortage of electric power from renewable energy, and indicates, for each workload ID, the application including the workload, the site and DC of the migration source, the site and DC of the migration target, the size of the data used, and electric power consumption, for example.

The lower part 9300 includes table 9310 showing optimization recommendations that suggest changes to placement policies as information for improving the operation of workload migration. Table 9310 indicates, for each workload ID, the application including the workload, the current placement policy, proposed changes to the placement policy, and an estimated reduction in CO₂ emissions resulting from the change. For example, the record in the first row of table 9310 indicates that the current placement policy is “01”, and that changing it to permit execution of the application at the site “03” can reduce CO₂ emissions by 100 kg.

In the above description, a workload is used as a migration unit for migrating an execution site. However, an application including one or more workloads may be used as a migration unit.

As described above, according to this embodiment, the workload replacement planning program 2470 migrates the execution site that executes the workload by the migration plan created using the site energy management table 2410. In addition, the workload replacement planning program 2470 acquires error information indicating the deviation amount, which is the magnitude of the deviation between the first forecast value, which is the value shown in the site energy management table 2410 used to create a migration plan for the target amount, which is at least one of the electric power demand amount or the renewable energy supply amount, and the second forecast value of the target amount, which is predicted after the first forecast value, and the deviation occurrence time point, which is the time at which the deviation occurs. Then, the workload replacement planning program 2470 creates a corrected migration plan in which the migration plan is corrected based on the error information and the load-related information (2420 to 2460). This allows the migration plan to be corrected according to the error of the forecast value of the electric power supply amount from renewable energy or the electric power demand amount, so that the electric power from renewable energy can be used more efficiently. This limits an increase in CO₂ emissions or an increase in costs, for example.

Furthermore, in this embodiment, the load-related information indicates a migration type, which is a change method for changing the execution site permitted for the workload, for each workload. Specifically, the migration types include data copy, switch access path, and sync. This makes it possible to create an appropriate corrected migration plan that takes the migration type into consideration.

Furthermore, in this embodiment, the workload replacement planning program 2470 calculates an estimated migration time based on the migration type and the type of storage that stores the data at the site. This allows for appropriate calculation of the estimated migration time.

Also, in the present embodiment, the workload replacement planning program 2470 selects a workload for which the execution site is to be migrated from the migration candidate loads, which are workloads whose estimated migration time is shorter than the time from the current time point to the deviation occurrence time point, based on the electric power consumption amount of each of the migration candidate loads and the deviation amount. This allows for the migration of the execution site of the workload that can be migrated before an error occurs, so an appropriate corrected migration plan can be created that enables more efficient use of electric power from renewable energy.

Furthermore, in this embodiment, the workload replacement planning program 2470 selects a workload for which the execution site is to be migrated such that the sum of the electric power consumption amounts of the workload for which the execution site is to be migrated corresponds to the deviation amount. Thus, an appropriate corrected migration plan can be created that enables more efficient use of electric power from renewable energy.

Furthermore, in this embodiment, for workloads whose migration type is the switch access path, the workload replacement planning program 2470 selects a workload for which the execution site is to be migrated from workloads that satisfy a predetermined performance requirement after migration. This ensures the performance requirement after migration.

The embodiments of the present disclosure described above are examples illustrative of the present disclosure, and are not intended to limit the scope of the present disclosure only to those embodiments. Those skilled in the art can implement the present disclosure in various other forms without departing from the scope of the disclosure.

What is claimed is:

1. A site management apparatus for managing a plurality of sites capable of executing a workload for performing calculation processing,
the site management apparatus comprising a processor and a memory, wherein
the memory is configured to store:
electric power management information indicating, for each of the sites, a forecast value of a target amount that is at least one of a supply amount, which is an amount of electric power from renewable energy to be supplied to the site, or a demand amount, which is an amount of electric power to be consumed at the site; and
load-related information indicating, for each workload, an electric power consumption amount that is an amount of electric power to be consumed by the workload, an execution site that is the site executing the workload, and an estimated migration time that is an estimate of a migration time required to migrate the execution site to another site, and
the processor is configured to:
migrate the execution site of each workload in accordance with a migration plan for migrating the execution site of each workload created using the electric power management information;
acquire error information indicating a deviation amount that is a magnitude of deviation between a first forecast value that is the forecast value indicated by electric power management information used to create the migration plan and a second forecast value of the target amount that is predicted after the first forecast value, and a deviation occurrence time point at which the deviation occurs; and
create a corrected migration plan, in which the migration plan is corrected, based on the error information and the load-related information.

2. The site management apparatus according to claim 1, wherein the load-related information further indicates, for each workload, a migration type that is a change method for changing the execution site permitted for the workload.

3. The site management apparatus according to claim 2, wherein the load-related information further indicates the execution site capable of executing the workload.

4. The site management apparatus according to claim 2, wherein the migration type includes data copy that copies data to be used in the workload from a migration source to a migration target of the execution site when the execution site is migrated, switch access path that does not copy the data to be used in the workload, and synchronization target migration that migrates the execution site to a site, to which data used by the workload is synchronously copied.

5. The site management apparatus according to claim 2, wherein the processor is configured to calculate the estimated migration time based on the migration type and a type of storage that stores data at the site.

6. The site management apparatus according to claim 1, wherein the processor is configured to create the corrected migration plan in which a workload for which the execution site is to be migrated is selected from migration candidate loads that are workloads each having the estimated migration time that is shorter than a time from a current time point to the deviation occurrence time point, based on an electric power consumption amount of each of the migration candidate loads and the deviation amount.

7. The site management apparatus according to claim 6, wherein the processor is configured to create the corrected migration plan in which a workload for which the execution site is to be migrated is selected from the migration candidate loads such that a sum of electric power consumption amounts of the workload for which the execution site is to be migrated corresponds to the deviation amount.

8. The site management apparatus according to claim 4, wherein the processor is configured to create the corrected migration plan in which, for the workloads of which migration type is the switch access path, a workload for which the execution site is to be migrated is selected from workloads that satisfy a predetermined performance requirement after migration, based on an electric power consumption amount of each of the workloads and the deviation amount.

9. The site management apparatus according to claim 1, wherein the processor is configured to receive information indicating a target site that is the site for which the workload is to be migrated, and to create the corrected migration plan in which a workload for which the execution site is to be migrated is selected from workloads that are executed at the target site.

10. A site management method using a site management apparatus for managing a plurality of sites capable of executing a workload for performing calculation processing,
the site management apparatus including a processor and a memory,
the method comprising: the memory
storing
electric power management information indicating, for each of the sites, a forecast value of a target amount that is at least one of a supply amount, which is an amount of electric power from renewable energy to be supplied to the site or a demand amount, which is an amount of electric power to be consumed at the site, and
load-related information indicating, for each workload, an electric power consumption amount that is an amount of electric power to be consumed by the workload, an execution site that is the site that executes the workload, and an estimated migration time that is an estimate of a migration time required to migrate the execution site to another site; and
by the processor
migrating the execution site of each workload in accordance with a migration plan for migrating the execution site of the workload created using the electric power management information,
acquiring error information indicating a deviation amount that is a magnitude of deviation between a first forecast value that is the forecast value indicated by electric power management information used to create the migration plan and a second forecast value of the target amount that is predicted after the first forecast value, and a deviation occurrence time point at which the deviation occurs, and
creating a corrected migration plan in which the migration plan is corrected based on the error information and the load-related information.
